(19) United States
(12) Patent Application Publication
(10) Pub. No.: US 2018/0275666 A1
(43) Pub. Date: Sep. 27, 2018

(54) AUTONOMOUS MOBILE APPARATUS RETURNING TO CHARGER TO BE CHARGED, AUTONOMOUS MOVING METHOD, AND NON-TRANSITORY COMPUTER-READABLE STORAGE MEDIUM

(71) Applicant: CASIO COMPUTER CO., LTD., Tokyo (JP)

(72) Inventor: Mitsuyasu NAKAJIMA, Tokyo (JP)

(73) Assignee: CASIO COMPUTER CO., LTD., Tokyo (JP)

(21) Appl. No.: 15/906,010

(22) Filed: Feb. 27, 2018

(30) Foreign Application Priority Data
Mar. 24, 2017 (JP) 2017-059966

(51) Int. Cl. G05D 1/02

(52) U.S. Cl. CPC G05D 1/0217; H02J 7/0042; G05D 1/0225

(57) ABSTRACT

An autonomous mobile apparatus that returns to a charger to be charged, the apparatus comprises a determiner that determines whether the apparatus is able to return to the charger, a location obtainer that obtains a predetermined location, an action planner that sets a destination, and sets a route to the destination, and a movement controller that controls a drive so that the apparatus is moved along the route that is set by the action planner, wherein, when the determiner determines that the apparatus is not able to return to the charger, the action planner sets the predetermined location obtained by the location obtainer as the destination.

### CROSS-REFERENCE TO RELATED APPLICATION

This application claims the benefit of Japanese Patent Application No. 2017-059966, filed on Mar. 24, 2017, the entire disclosure of which is incorporated by reference herein.

### FIELD

This application relates to a technique for an autonomous mobile apparatus that returns to a charger to be charged.

### BACKGROUND

Autonomous mobile apparatuses like a robotic cleaner that autonomously moves for indoor cleaning are becoming more widespread. Because of being driven by a battery, an autonomous mobile apparatus is usually designed to autonomously return to a battery charger to be charged when the remaining battery level is low. For example, Unexamined Japanese Patent Application Kokai Publication No. 2008-181177 describes an autonomous mobile apparatus that detects a return signal (beacon) transmitted by a battery charger to return to the charger.

### SUMMARY

To achieve the above-described objective, an autonomous mobile apparatus according to the present disclosure returns to a charger to be charged,includes:

a determiner that determines whether the apparatus is able to return to the charger;

a location obtainer that obtains a predetermined location;

an action planner that sets a destination, and sets a route to the destination; and

a movement controller that controls a drive so that the apparatus is moved along the route that is set by the action planner,

wherein, when the determiner determines that the apparatus is not able to return to the charger, the action planner sets the predetermined location obtained by the location obtainer as the destination.

### BRIEF DESCRIPTION OF THE DRAWINGS

A more complete understanding of this application can be obtained when the following detailed description is considered in conjunction with the following drawings, in which:

FIG. 1 is an external view of an autonomous mobile apparatus according to Embodiment 1 of the present disclosure;

FIG. 2 is an external view of a charger according to Embodiment 1;

FIG. 3 is a diagram for explaining a return signal transmitted by the charger according to Embodiment 1;

FIG. 4 is a diagram illustrating a functional configuration of the autonomous mobile apparatus according to Embodiment 1;

FIG. 5 shows an example of a map according to Embodiment 1;

FIG. 6 shows a list of operating states of the autonomous mobile apparatus according to Embodiment 1;

FIG. 7 is a flowchart showing an overall autonomous moving process according to Embodiment 1;

FIG. 8 is a flowchart showing an action planning process according to Embodiment 1;

FIG. 9 is a flowchart showing a normal operation process included in the action planning process according to Embodiment 1;

FIG. 10 is a flowchart showing a threshold correcting process according to Embodiment 1;

FIG. 11 is a diagram illustrating a functional configuration of an autonomous mobile apparatus according to Embodiment 2 of the present disclosure; and

FIG. 12 is a flowchart showing a carriage history storing process according to Embodiment 2.

### DETAILED DESCRIPTION

An autonomous mobile apparatus, an autonomous moving method, and a non-transitory computer-readable storage medium according to embodiments of the present disclosure will now be described with reference to the drawings. Identical reference symbols are given to identical or equivalent parts throughout the drawings.

### Embodiment 1

An autonomous mobile apparatus according to embodiments of the present disclosure moves autonomously and appropriately for the intended use while creating a map of a surrounding area. Examples of the intended use include a use for security monitoring, indoor cleaning, pet animals, or toys.

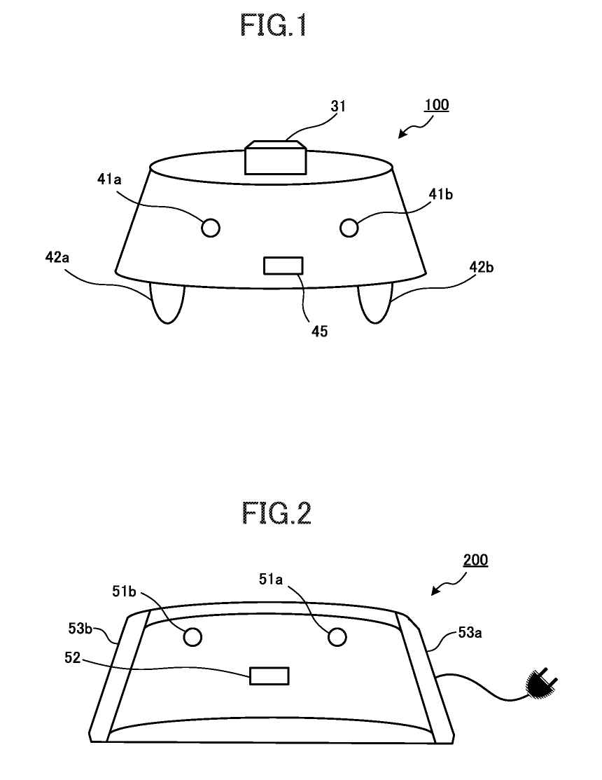

As illustrated in FIG. 1, the autonomous mobile apparatus 100 includes, in appearance, an obstacle sensor 31, a return signal receiver 41 (41a, 41b), a drive 42 (42a, 42b), and a charger connector 45. The autonomous mobile apparatus 100 may further include an imaging device (not illustrated in FIG. 1). As illustrated in FIG. 2, a charger 200 for charging a battery in the autonomous mobile apparatus 100 includes, in appearance, a return signal transmitter 51 (51a, 51b), a power supply 52, and a guide 53 (53a, 53b).

When the charger connector 45 in the autonomously mobile apparatus 100 connects with the power supply 52 in the charger 200, the autonomous mobile apparatus 100 receives power supplied from the charger 200 to be able to charge a battery built in the autonomous mobile apparatus 100. The charger connector 45 and the power supply 52 are connection terminals to be connected with each other. The drive 42 drives the autonomous mobile apparatus 100 to move back and forth, with the result that the autonomous mobile apparatus 100 is connected to, and disconnected from, the charger 200. When the autonomous mobile apparatus 100 is going to be connected (docked) to the charger 200, the autonomous mobile apparatus 100 moves along the guide 53 (53a, 53b) included in the charger 200 so that the charger connector 45 and the power supply 52 are connected together.

The obstacle sensor 31 is a laser range scanner capable of detecting a nearby object (obstacle) and measuring a distance to the object (obstacle). The obstacle sensor 31 includes, for example, a two-dimensional laser scanner. The obstacle sensor 31 scans an area within a predetermined angular range (200 degrees, for example) in a horizontal direction in parallel to the floor surface with a laser beam, so that the distance to a nearby object being present within the angular range can be obtained even when the autonomous mobile apparatus 100 is at rest. The obstacle sensor 31 is used for the autonomous mobile apparatus 100 to create a map (obstacles map), which will be described later.

The return signal receiver 41 in the autonomous mobile apparatus 100 is a device for receiving a return signal (infrared beacon) transmitted by the charger 200. Two return signal receivers 41 are disposed on the front of the autonomous mobile apparatus 100, namely the return signal receiver 41a and the return signal receiver 41b on the left and on the right, respectively, of the front. The return signal transmitter 51 in the charger 200 is a device for transmitting a return signal to the autonomous mobile apparatus 100. Two return signal transmitters are disposed on the front of the charger 200, namely the return signal transmitter 51a and the return signal transmitter 51b on the right and on the left, respectively, of the front. The return signal transmitted by the return signal transmitter 51a is different from the return signal transmitted by the return signal transmitter 51b. Thus, the return signal receiver 41 can distinguish sources of incoming return signals between the right and left return signal transmitters 51.

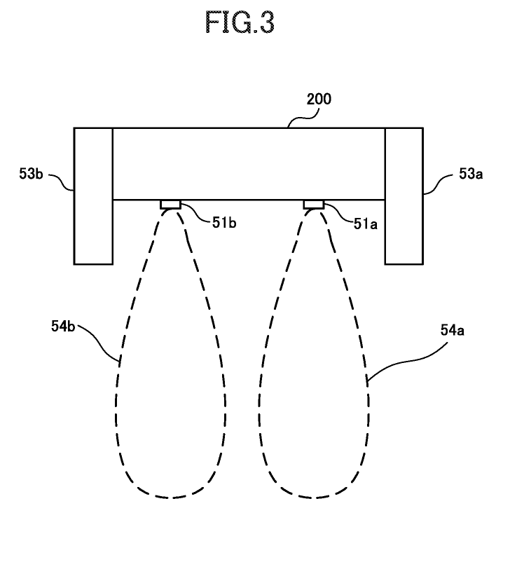

FIG. 3 shows an example of right and left signal coverages 54 (54a, 54b) in which return signals transmitted by the return signal transmitters 51 in the charger 200 can be received. When being present inside the signal coverage 54a, the return signal receiver 41 in the autonomous mobile apparatus 100 can receive a return signal transmitted by the return signal transmitter 51a. When being present inside the signal coverage 54b, the return signal receiver 41 in the autonomous mobile apparatus 100 can receive a return signal transmitted by the return signal transmitter 51b. In other words, when being present inside the signal coverage 54, the autonomous mobile apparatus 100 knows the direction to the charger 200. When the return signal receiver 41a is receiving return signals from the return signal transmitter 51a, and when the return signal receiver 41b is receiving return signals from the return signal transmitter 51b, the autonomous mobile apparatus 100 can move onward while adjusting its orientation, and can be finally docked to the charger 200. When the autonomous mobile apparatus 100 is docked to the charger 200, the charger connector 45 and the power supply 52 are connected together, enabling the battery to be charged.

The drive 42 is an independently driven two-wheel type transportation device equipped with a wheel and a motor. The autonomous mobile apparatus 100 is capable of back-and-forth parallel movement (translational movement) caused by the two wheels driving in the same direction, rotation on the site (turning around) caused by the two wheels driving in opposite directions, and pivoting around (translational movement+rotation (turning around) caused by the two wheels driving at different speeds. Each of the wheels is equipped with a rotary encoder, which allows for measurement of the number of rotations of the wheel. By using such rotation number and a geometric relationship among the diameter of a wheel, the distance between wheels, and the like, a translational movement amount and a rotation amount can be calculated. For example, letting D be the diameter of a wheel and letting R be the number of rotations of the wheel (measured by the rotary encoder), the translational movement amount of the wheel on the ground is expressed by π·D·R. Letting D be the diameter of a wheel, I be the distance between wheels, R_{R} be the number of rotations of the right wheel, and R_{L} be the number of rotations of the left wheel, the rotation amount for turning around is expressed by 360°×D×(R_{L}−R_{R})/(2×I), where clockwise rotation is forward rotation. By adding together measurements of the parallel movement amount and the rotation amount sequentially, the drive 42 can serve as what is called odometry (mechanical odometry) to measure the position (the position and orientation relative to the starting position and orientation) of the autonomous mobile apparatus 100.

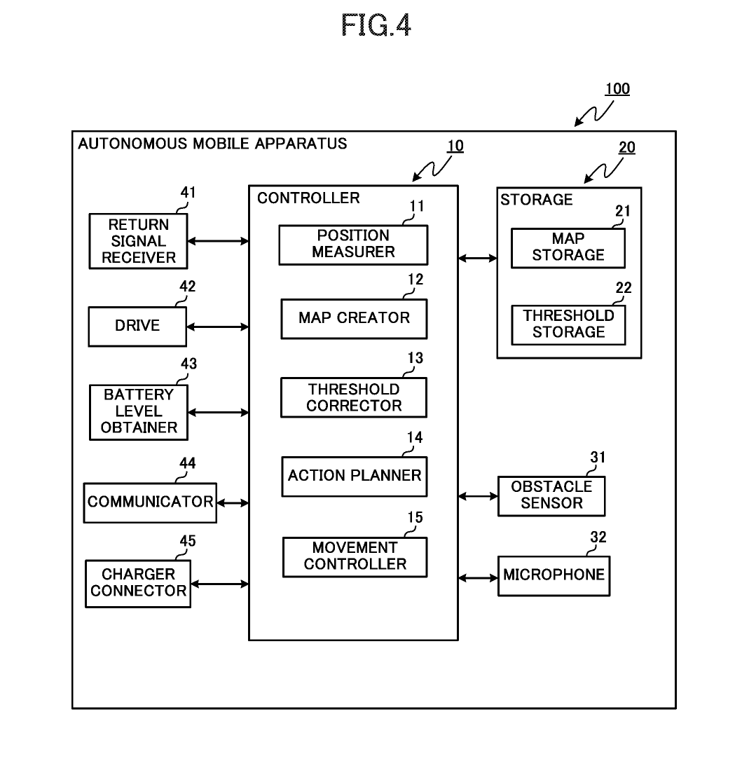

As illustrated in FIG. 4, the autonomous mobile apparatus 100 includes a controller 10, a storage 20, a microphone 32, a battery level obtainer 43, and a communicator 44, in addition to the obstacle sensor 31, the return signal receiver 41 (41a, 41b), the drive 42 (42a, 42b), and the charger connector 45.

The controller 10, which includes a central processing unit (CPU), implements function of the components described later (a position measurer 11, a map creator 12, a threshold corrector 13, an action planner 14, and a movement controller 15) by executing a program stored in the storage 20. The controller 10 further includes a timer (not illustrated) to measure an elapsed time.

The storage 20 includes read only memory (ROM), random access memory (RAM), and the like, and functionally includes a map storage 21 and a threshold storage 22. The ROM already stores programs to be executed by the CPU in the controller 10 and necessary data for executing the programs. The RAM stores data created or edited when programs are running

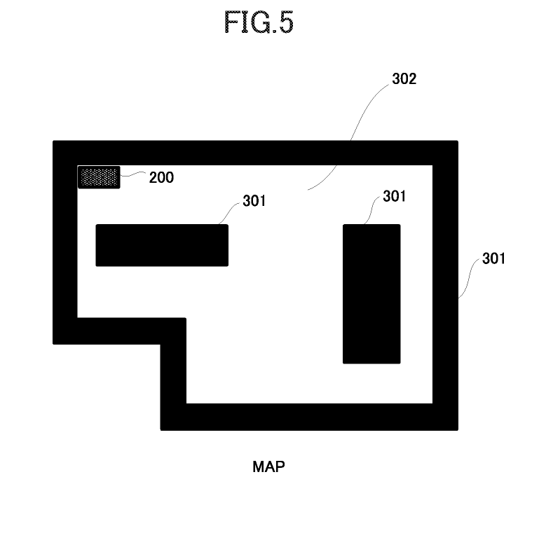

The map storage 21 stores a map that the map creator 12 creates on the basis of information provided by the obstacle sensor 31. As illustrated in FIG. 5, the map records absence/presence of an obstacle 301 positioned at its corresponding grid or grids, where the floor surface is divided into grids, for example 5 cm×5 cm each (a free space 302 contains no obstacle 301). In addition, the map records the position of the charger 200. In the example of the map in FIG. 5, the charger 200, the obstacles 301, and the free space 302 are recorded.

The threshold storage 22 already stores different thresholds (TH1, TH2, and TH3) used for comparison with values of remaining battery levels during the action planning process, which will be described later. The threshold storage 22 also stores default values (TH1_Default, TH2_Default, and TH3_Default) that are preset to these thresholds. TH1_Default (the default value of a first threshold) is a value of the remaining battery level at which the autonomous mobile apparatus 100 following a shortest possible route to the charger 200 is highly likely to fail to return to the charger 200 when the remaining battery level falls below the default value. TH2_Default (the default value of a second threshold) is a value of the remaining battery level with some capacity at which the autonomous mobile apparatus 100 is highly likely to return to the charger 200 successfully, on condition that the autonomous mobile apparatus 100 has already created a map covering a route to the charger 200. TH3_Default (the default of a third threshold) is a value of the remaining battery level at which the autonomous mobile apparatus 100 has no trouble continuing operation without paying attention to charging, as long as the battery level is at least equal to the default value.

The microphone 32 is a directional microphone that detects human voices. The autonomous mobile apparatus 100 knows the direction in which a person is detected, by using the microphone 32 to detect a change in loudness of a human voice while rotated by the drive 42.

The autonomous mobile apparatus 100 moving toward a person would be more likely to be found by the person. In other words, the microphone 32 serves as a person-found location obtainer that obtains a location at which the autonomous mobile apparatus 100 is easily found by a person. The autonomous mobile apparatus 100 may include an imaging device (not illustrated) instead of, or in addition to, the microphone 32 so as to detect a location where a person is present by recognizing a person in an image taken by the imaging device. In this case, the imaging device serves as the person-found location obtainer. The imaging device includes a monocular imaging apparatus (camera) to obtain images (frames) at, for example, 30 frames per second (30 fps).

The battery level obtainer 43 obtains the remaining level of a battery in the autonomous mobile apparatus 100. Any appropriate method may be used to obtain the battery level. For example, the battery level obtainer 43 may obtain the battery level by measuring the existing battery voltage and calculating the battery level from the voltage.

The communicator 44 is a module for communicating with an external apparatus, or, if applicable, a wireless module having an antenna for wirelessly communicating with an external apparatus. For example, the communicator 44 may be a wireless module for short distance wireless communication based on Bluetooth®. The communicator 44 enables the autonomous mobile apparatus 100 to deliver and receive data to and from the outside of the apparatus 100.

The following describes a functional configuration of the controller 10 in the autonomous mobile apparatus 100. The controller 10 implements functions of the position measurer 11, the map creator 12, the threshold corrector 13, the action planner 14, and the movement controller 15 to control movement and the like of the autonomous mobile apparatus 100. The controller 10 supports multithreading, and thus can execute multiple threads (different process flows) concurrently.

The position measurer 11 measures the position of the autonomous mobile apparatus 100 on the basis of motions of the wheel and motor in the drive 42. Specifically, on the assumption that the ground has no uneven height and no wheel skid occurs, the traveling distance of a wheel on the ground is expressed as π·D·R, where D is the diameter of the wheel and R is the number of rotations of the wheel measured by a rotary encoder. Thus, from these values and the distance between wheels, the amount of translational movement, the translational direction, and the amount of change in orientation (rotation angle) can be obtained. By adding these values sequentially, the position measurer 11 can serve as odometry to measure the position and orientation of the autonomous mobile apparatus 100. When the ground has uneven height, the height direction needs to be taken into consideration to calculate the amount of translation movement. For this purpose, the autonomous mobile apparatus 100 may include an acceleration sensor (not illustrated), with which the amount of change in height can be determined, and thus the distance of translational movement can be obtained taking into consideration the height direction.

The map creator 12 creates a map like the one illustrated in FIG. 5 by using information supplied by the obstacle sensor 31, and stores the map into the map storage 21.

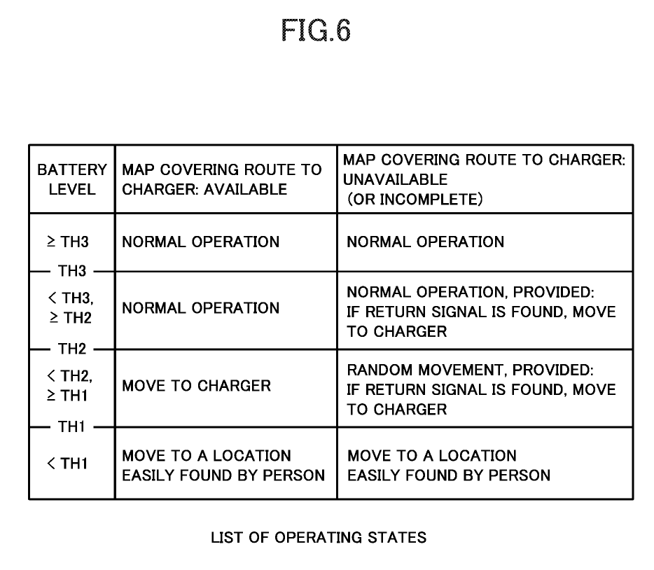

The threshold corrector 13 modifies the three thresholds (TH1, TH2, and TH3) concerning battery levels during the threshold correcting process, which will be described later. The autonomous mobile apparatus 100 runs in one of a plurality of operating states shown in FIG. 6, depending on the state of the map stored in the map storage 21 and on the remaining battery level. The threshold corrector 13 modifies the battery level thresholds (TH1, TH2, and TH3) at which the autonomous mobile apparatus 100 switches between operating states so that the apparatus 100 can more surely return to the charger 200. In addition, in the case where the autonomous mobile apparatus 100 is highly likely to fail to return to the charger 200, the threshold corrector 13 ensures that the apparatus 100 moves to a location easily found by a person so that the apparatus 100 is carried by a person to the charger 200.

The action planner 14 sets a destination and a route on the basis of the state of the map stored in the map storage 21, the remaining battery level, and the current operation mode. For example, the action planner 14 classifies operating states of the apparatus 100 into a plurality of different stages as shown in FIG. 6, on the basis of the relationship of levels between the remaining battery level and each of the thresholds stored in the threshold storage 22. An operation mode, as used herein, is a defined mode of action of the autonomous mobile apparatus 100. The autonomous mobile apparatus 100 has three operation modes: a “free traveling mode” in which the apparatus 100 randomly moves, a “map creation mode” in which the coverage of a map is increasingly extended, and a “destination-specified mode” in which the apparatus 100 moves to a location specified by an upper-level application. A condition for transitioning between operation modes may be predetermined. Examples of such condition may include that the initial map creation mode should change to the free traveling mode when a map has been created to a certain extent (for example, after a time of 10 minutes has passed in the map creation mode), and should change to the destination-specified mode (in this case the charger 200 is specified as the destination) when the charger 200 level becomes low. Alternatively, such condition may be defined in accordance to an instruction given from the outside (given by a user, an upper-level application, or the like). For route setting, the action planner 14 sets a route from the current position of the apparatus 100 to the destination, on the basis of the map created by the map creator 12.

The movement controller 15 controls the drive 42 so that the apparatus 100 is moved along the route planned by the action planner 14.

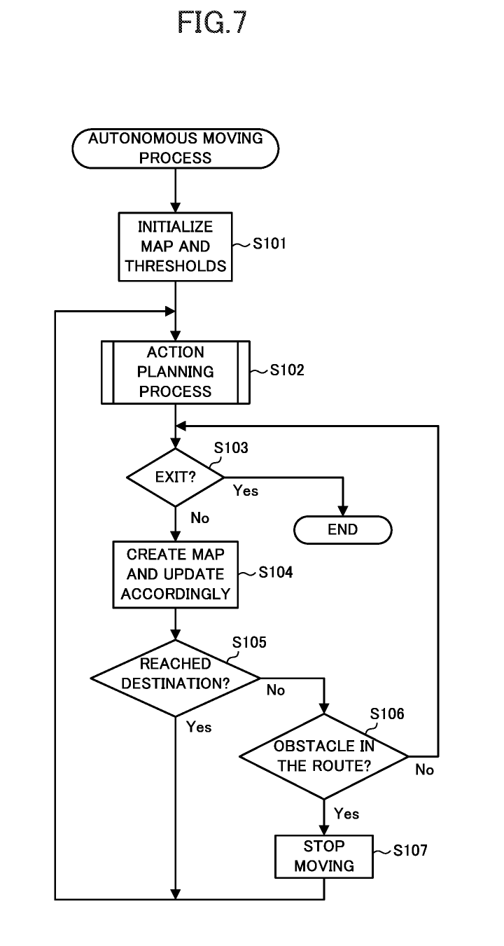

The foregoing has described a functional configuration of the autonomous mobile apparatus 100. Various processes initiated in the autonomous mobile apparatus 100 will now be described. When the power is off, the autonomous mobile apparatus 100 is connected to the charger 200 and kept charged. When turned on, the autonomous moving process, which will be described later, and an upper-level application appropriate for the intended use are concurrently executed in different threads while the autonomous mobile apparatus 100 is connected to the charger 200. In addition, the threshold correcting process, which will be described later, is concurrently executed in a thread other than those for the other processes at predetermined intervals (every one minute, for example), triggered by the timer included in the controller 10 for correcting thresholds. The upper-level application may be, for example, an application for indoor cleaning. The upper-level application gives instructions about operation mode setting, stopping an operation, and the like to the autonomous moving process. The autonomous moving process for the autonomous mobile apparatus 100 will now be described below with reference to FIG. 7, which shows a flowchart of the overall autonomous moving process.

First, the controller 10 in the autonomous mobile apparatus 100 initializes both the map stored in the map storage 21 and the thresholds stored in the threshold storage 22 (step S101). Since the autonomous mobile apparatus 100 starts moving from the charger 200, as of the startup the map is initialized with the information representing that “the autonomous mobile apparatus 100 is located at the charger”. The thresholds (TH1, TH2, and TH3) are initialized to their respective default values (TH1_Default, TH2_Default, and TH3_Default).

Next, the controller 10 executes the action planning process (step S102). Step S102 may be called an action planning step. In the action planning process, the autonomous mobile apparatus 100 sets a destination and a route on the basis of the state of the map stored in the map storage 21, the remaining battery level, and the current operation mode. The action planning process will be described in detail later.

Next, the controller 10 determines whether an instruction to exit the operation has been received from the upper-level application (step S103). If an instruction to exit the operation has been received (Yes in step S103), the controller 10 exits the autonomous moving process. If an instruction to exit the operation has not been received (No in step S103), the map creator 12 creates a map using the position of the autonomous mobile apparatus 100 measured by the position measurer 11 and the distance to an obstacle 301 measured by the obstacle sensor 31, and updates the map accordingly (step S104). Step S104 may be called a map creating step.

Next, the controller 10 determines whether the autonomous mobile apparatus 100 has reached the destination specified in step S102 (step S105). If the apparatus 100 has reached the destination (Yes in step S105), the processing returns to step S102.

If the apparatus 100 has not reached the destination (No in step S105), the controller 10 determines whether an obstacle 301 is in the current route (step S106). If no obstacle 301 is in the route (No in step S106), the processing returns to step S103. If an obstacle 301 is in the route (Yes in step S106), the movement controller 15 stops the movement (step S107) and goes to step S102. Hence, when the apparatus 100 is prevented from moving onward by an obstacle 301 present in the defined route to the destination, the action planning process is executed to set a destination and a route again.

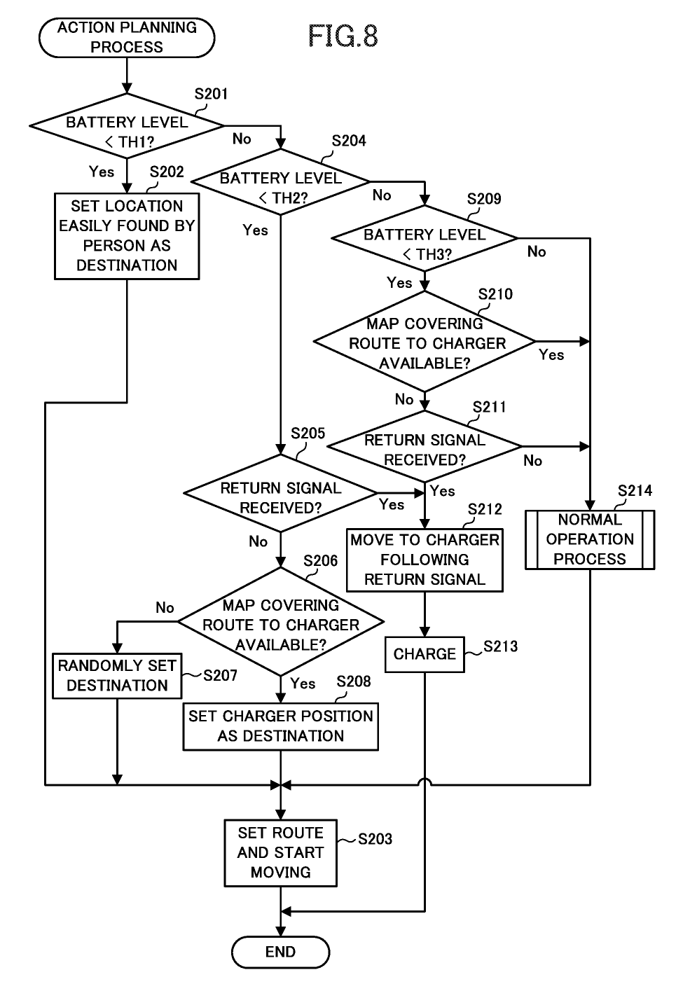

The action planning process executed in step S102 in the autonomous moving process will now be described with reference to FIG. 8. In the action planning process, the autonomous mobile apparatus 100 sets a destination and a route on the basis of the state of the map stored in the map storage 21, the remaining battery level, and the current operation mode.

First, the action planner 14 determines whether the remaining battery level is lower than the threshold TH1 (first threshold) (step S201). If the remaining battery level is lower than the threshold TH1 (Yes in step S201), the action planner 14 specifies a location easily found by a person as the destination (step S202). For example, if the microphone 32 has detected a human voice, the action planner 14 specifies a location away from the position of the autonomous mobile apparatus 100 by a predetermined distance (3 m, for example) along the direction toward the human voice, as the destination. If the autonomous mobile apparatus 100 includes an imaging device, a person can be detected through image recognition of a face or the like on an image taken by the imaging device. In this case, the action planner 14 specifies a location where a person detected through image recognition is present, as the destination.

If no human voice can be detected by the microphone 32 or any other device, or if no person can be detected by the imaging device, the controller 10 obtains a large space having few obstacles 301 nearby from the map stored in the map storage 21, as a location easily found by a person (in this case, the controller 10 serves as a person-found location obtainer that obtains a location that can be easily found by a person). A large space having few obstacles 301 nearby can be regarded as a location where a person has difficulty in hiding behind an obstacle 301. Then, a location where a person has difficulty in hiding can be regarded as a location where the person can easily find the autonomous mobile apparatus 100. Thus, the person-found location obtainer obtains such location as a place where the apparatus 100 is easily found by a person. The action planner 14 specifies, as the destination, the location that is obtained by the controller 10 and is easily found by a person. Step S202 may be called a person-found location obtaining step.

On the basis of the map stored in the map storage 21, the action planner 14 sets a route to the location specified as the destination. Then, the movement controller 15 starts controlling the drive 42 so that the apparatus 100 follows the route set by the action planner 14. Consequently, the autonomous mobile apparatus 100 starts moving (step S203). Step S203 may be called a movement controlling step. Then, the action planner 14 exits the action planning process.

In step S201, if the remaining battery level is equal to or higher than the threshold TH1 (No in step S201), the action planner 14 determines whether the remaining battery level is lower than the threshold TH2 (second threshold) (step S204). If the remaining battery level is lower than the threshold TH2 (Yes in step S204), the action planner 14 determines whether the return signal receiver 41 has received a return signal from the charger 200 (step S205). If the return signal receiver 41 has received a return signal (Yes in step S205), the movement controller 15 controls the drive 42 so that the autonomous mobile apparatus 100 is moved to the charger 200 in accordance with the return signal (step S212).

In order that the apparatus 100 moves to the charger 200, the movement controller 15 controls the drive 42 so that the return signal receiver 41a receives a return signal from the return signal transmitter 51a and the return signal receiver 41b receives a return signal from the return signal transmitter 51b. When the intensity of a received return signal has increased, the movement controller 15 reduces the moving speed, and then the autonomous mobile apparatus 100 is supported by the guides 53 disposed on the charger 200, and then connected (docked) to the charger 200.

When the autonomous mobile apparatus 100 is connected (docked) to the charger 200, the controller 10 notifies the upper-level application that the apparatus 100 has been docked to the charger 200 and the charging has started (step S213). The controller 10 exits the action planning process. Subsequently, the controller 10 waits for an instruction from the upper-level application and resumes the autonomous moving process following the instruction, which is not illustrated for eliminating untidiness.

If no return signal has been received (No in step S205), the action planner 14 determines whether a map covering a route to the charger 200 is available (step S206). In other words, the determination is made whether the action planner 14 can create a route to the charger 200 (a map is available) or not (a map is not available) on the basis of the map stored in the map storage 21. If a map is available (Yes in step S206), the action planner 14 sets the position of the charger 200 as the destination, on the basis of the map stored in the map storage 21 (step S208), and then goes to step S203.

If a map is not available (No in step S206), the action planner 14 randomly sets a destination (step S207), and then goes to step S203. To “randomly set a destination”, the action planner 14 may randomly select a location having no obstacle 301 by referring to the map stored in the map storage 21, or may randomly set a moving direction and a moving distance without referring to the map.

In step S204, if the remaining battery level is equal to or higher than the threshold TH2 (No in step S204), the action planner 14 determines whether the remaining battery level is lower than the threshold TH3 (third threshold) (step S209). If the remaining battery level is equal to or higher than the threshold TH3 (No in step S209), the action planner 14 executes the normal operation process (step S214), which will be described later, and then goes to step S203.

If the remaining battery level is lower than the threshold TH3 (Yes in step S209), the action planner 14 determines whether a map covering a route to the charger 200 is available (step S210). In other words, as described above, the determination is made whether the action planner 14 can create a route to the charger 200 (a map is available) or not (a map is not available) on the basis of the map stored in the map storage 21. If a map is available (Yes in step S210), the action planner 14 goes to step S214. If a map is not available (No in step S210), the action planner 14 determines whether the return signal receiver 41 has received a return signal from the charger 200 (step S211). If a return signal has been received (Yes in step S211), the action planner 14 goes to step S212. If a return signal has not been received (No in step S211), the action planner 14 goes to step S214.

By executing the action planning process described above, the autonomous mobile apparatus 100 operates so as to be able to return to the charger 200 by itself to the extent possible, depending on availability of a map and on the remaining battery level, as seen in FIG. 6. When the apparatus 100 is highly likely to fail to return to the charger 200 by the apparatus 100 itself, the apparatus 100 moves to a location that can be easily found by a person. By operating in such a manner, the autonomous mobile apparatus 100 is allowed to be carried to the charger 200 by a person when the apparatus 100 is unable to return to the charger 200 by the apparatus 100 itself.

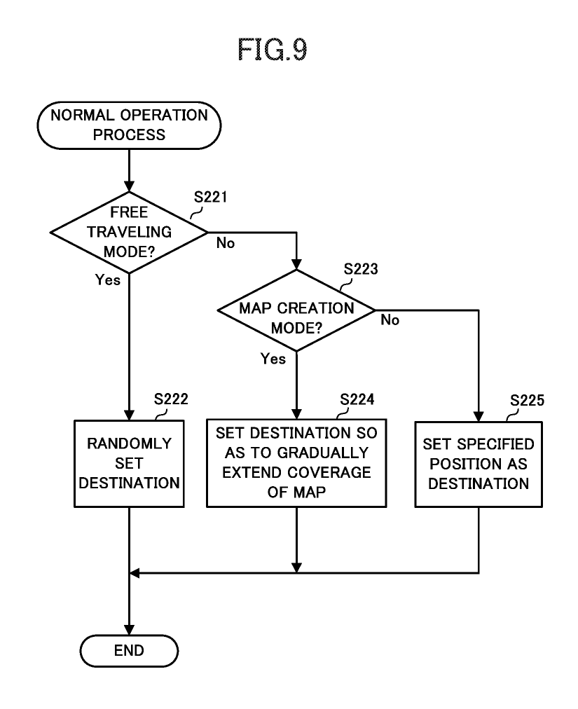

The normal operation process executed in step S214 will now be described with reference to FIG. 9. In the normal operation process, the autonomous mobile apparatus 100 sets a destination that depends on the operation mode as instructed by the upper-level application.

First, the action planner 14 determines whether the autonomous mobile apparatus 100 is currently in the free traveling mode, which is one of the operation modes (step S221). As described above, there are three operation modes: the free traveling mode, the map creation mode, and the destination-specified mode. If the operation mode is the free traveling mode (Yes in step S221), the action planner 14 randomly sets a destination (step S222), exits the normal operation process, and goes to step S203 in the action planning process. As described above, to “randomly set a destination”, the action planner 14 may randomly select a location having no obstacle 301 by referring to the map stored in the map storage 21, or may randomly set a moving direction and a moving distance without referring to the map.

If the operation mode is not the free traveling mode (No in step S221), the action planner 14 determines whether the operation mode is the map creation mode (step S223). If the operation mode is the map creation mode (Yes in step S223), the action planner 14 sets a destination so that the coverage of the map is increasingly extended (step S224), exits the normal operation process, and goes to step S203 in the action planning process. The foregoing “setting a destination so that the coverage of the map is increasingly extended” means setting a destination at a point on the boundary between a spot whose map is already created and a spot whose map is not created. If there is no location applicable to such point, the action planner 14 sets a destination at any location that is unlikely to be affected by an obstacle 301 on the map.

If the operation mode is not the map creation mode (No in step S223), the action planner 14 sets the location specified by the upper-level application as the destination (step S225), exits the normal operation process, and goes to step S203 in the action planning process.

By executing the normal operation process described above, the autonomous mobile apparatus 100 can behave as if freely traveling in the free traveling mode, extend the coverage of a map in the map creation mode, and move straight to the destination specified by the upper-level application in the destination-specified mode.

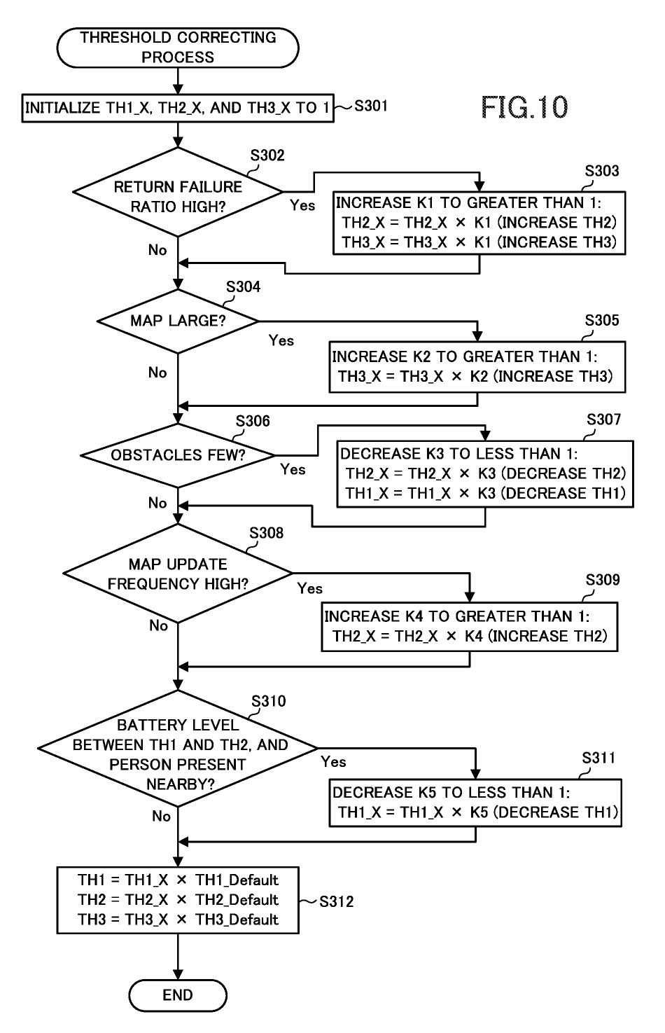

Now, referring to FIG. 10, the following describes the threshold correcting process executed at predetermined intervals (threshold correcting intervals) triggered by the timer included in the controller 10.

First, the threshold corrector 13 initializes all the threshold correction factors TH1_X, TH2_X, and TH3_X to 1 (step S301). A threshold correction factor indicates an amount by which a threshold is corrected relative to its default value. Multiplying the default value by the threshold correction factor produces a threshold value.

Next, the threshold corrector 13 determines whether the return failure rate is relatively high (equal to or greater than the reference failure rate, which is 50%, for example) (step S302). The return failure rate is expressed by a fraction, where the denominator is the number of times the position of the charger 200 is set to the destination in step S208 in the action planning process (FIG. 8), and the numerator is the number of times the apparatus subsequently fails to return to the charger 200 and then the remaining battery level falls below TH0. The return failure rate is updated to a new value every time the autonomous mobile apparatus 100 is connected (docked) to the charger 200 by the apparatus 100 itself (successful return) or manually by a person (failed return).

If the return failure rate is higher (Yes in step S302), the threshold corrector 13 sets a variable K1 to a value greater than 1 (1.2, for example) and multiplies TH2_X and TH3_X each by K1 to slightly increase these values (step S303). For a higher return failure rate, this step allows the autonomous mobile apparatus 100 to start moving to the charger 200 earlier. By starting to move to the charger 200 earlier, the autonomous mobile apparatus 100 has some extra time, and thus is more likely to succeed in returning to the charger 200 by the apparatus 100 itself. For this reason, the thresholds TH2 and TH3 each are changed to a slightly higher value. Then, the processing goes to step S304.

If the return failure rate is not higher (No in step S302), the threshold corrector 13 determines whether the map stored in the map storage 21 is relatively large in size (equal to or greater than the reference map area, which is 10 tatami-mats, for example) (step S304). If the map is larger (Yes in step S304), the threshold corrector 13 sets a variable K2 to a value greater than 1 (1.2, for example) and multiplies TH3_X by K2 to slightly increase the value (step S305). A larger map represents that the autonomous mobile apparatus 100 moves around in a larger area, which means the autonomous mobile apparatus 100 is less likely to find a return signal by chance. In such situation, it would be safe for the autonomous mobile apparatus 100 to start moving to the charger 200 as soon as a return signal is found. For this reason, the threshold TH3 is changed to a slightly higher value. Then, the processing goes to step S306.

If the map stored in the map storage 21 is not larger (No in step S304), the threshold corrector 13 determines whether obstacles 301 included in the map stored in the map storage 21 are relatively few (whether the ratio of the area of obstacles 301 to the area of the created map is equal to or less than the reference obstacle ratio (10%, for example) (step S306). If the obstacles 301 are fewer (Yes in step S306), the threshold corrector 13 sets a variable K3 to a value smaller than 1 (0.8, for example) and multiplies TH2_X and TH1_X each by K3 to slightly decrease these values (step S307). As the obstacles 301 are fewer, the map is simpler, and thus it would be easier for the apparatus to move to the charger 200 (or to a person). In this case, the autonomous mobile apparatus 100 can fully perform its functions by continuing the normal operation for a longest time possible. For this reason, the thresholds TH2 and TH1 each are changed to a slightly smaller value. Then, the processing goes to step S308.

If the obstacles 301 are not fewer (No in step S306), the threshold corrector 13 determines whether the map is updated relatively frequently (equal to or higher than the reference update frequency (once/minute, for example) (step S308). If the map is updated more frequently (Yes in step S308), the threshold corrector 13 sets a variable K4 to a value greater than 1 (1.2, for example) and multiplies TH2_X by K4 to slightly increase the value (step S309). A higher frequency of updating the map implies that a larger number of obstacles 301 are being moved. If this is the case, in spite of the map guiding to the charger 200, the autonomous mobile apparatus 100 may possibly hit an obstacle 301 on its way to the charger 200. By starting to move to the charger 200 earlier, the autonomous mobile apparatus 100 has a chance of circumventing an obstacle 301 even after hitting the obstacle 301 on the way to the charger 200, and thus is more likely to successfully return to the charger by the apparatus 100 itself. For this reason, the threshold TH2 is changed to a slightly greater value. Then, the processing goes to step S310.

If the frequency of updating the map is not higher (No in step S308), the threshold corrector 13 determines whether the remaining battery level is at least equal to the threshold TH1 and lower than the threshold TH2, and whether a person is present nearby (step S310). To know whether a person is present nearby, the threshold corrector 13 determines whether the microphone 32 has detected a human voice. If an imaging device is included, the threshold corrector 13 may also determine whether a person is detected through image recognition on an image taken by the imaging device.

If the remaining battery level is at least equal to the threshold TH1 and lower than the threshold TH2, and a person is present nearby (Yes in step S310), the threshold corrector 13 sets a variable K5 to a value slightly smaller than 1 (0.8, for example) and multiplies TH1_X by K5 to slightly decrease the value (step S311). As long as a person is present nearby, the autonomous mobile apparatus 100 failing to return to the charger 200 is carried to the charger 200 by the person. For this reason, TH1 is changed to a slightly smaller value. Then, the processing goes to step S312.

If the remaining battery level is lower than the threshold TH1 or at least equal to the threshold TH2, or if no person is present nearby (No in step S310), the threshold corrector 13 corrects the thresholds (TH1, TH2, and TH3) by multiplying the threshold correction factors (TH1_X, TH2_X, and TH3_X) by the threshold default values (TH1_Default, TH2_Default, and TH3_Default), respectively (step S312). The threshold corrector 13 exits the threshold correcting process.

In the threshold correcting process described above, thresholds are dynamically corrected depending on the rate of failure to return to the charger 200, the size of the map, the sparseness of obstacles 301, the frequency of updating the map, the presence or absence of a person, and the like. As a result, the autonomous mobile apparatus 100 can achieve both continuing the normal operation for a longest time possible and reducing the rate of failure to return to the charger 200. Furthermore, even when failing to return to the charger 200, the autonomous mobile apparatus 100 is allowed to be carried to the charger 200 by a person by moving to a possible location that can be easily found by a person.

### Embodiment 2

In Embodiment 1 described above, when the autonomous mobile apparatus 100 fails to detect a person, the action planner 14 uses the map stored in the map storage 21 to specify a large space having few obstacles 301 nearby as the destination. This is because a larger space creates a higher possibility that a person is present in, or passes through, the space. The following describes Embodiment 2, which uses a history to further increase the probability that the autonomous mobile apparatus is found by a person when the apparatus cannot detect a person.

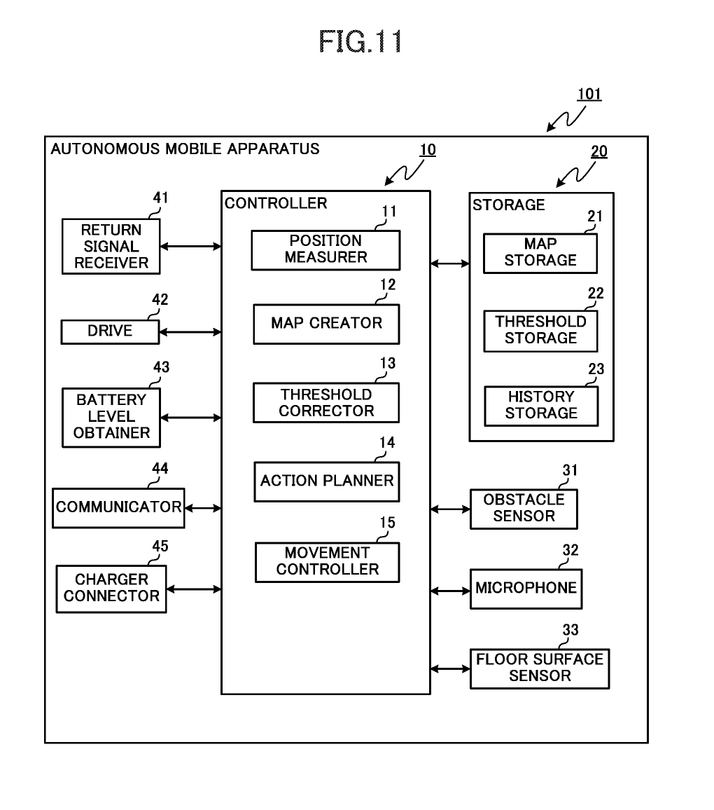

As illustrated in FIG. 11, an autonomous mobile apparatus 101 according to Embodiment 2 of the present disclosure includes a history storage 23 and a floor surface sensor 33, in addition to the configuration of the autonomous mobile apparatus 100 according to Embodiment 1. The other components are identical to those of the autonomous mobile apparatus 100 according to Embodiment 1.

In a carriage history storing process, which will be described later, when the autonomous mobile apparatus 101 is carried to the charger 200 by a person, the position at which the person picks up the autonomous mobile apparatus 101 is stored into the history storage 23.

The floor surface sensor 33 detects whether the autonomous mobile apparatus 101 is on a floor. When the autonomous mobile apparatus 101 is moving on the floor, the floor surface sensor 33 detects that the autonomous mobile apparatus 101 is on the floor. When the autonomous mobile apparatus 101 is picked up by a person, the floor surface sensor 33 detects that the autonomous mobile apparatus 101 is off the floor.

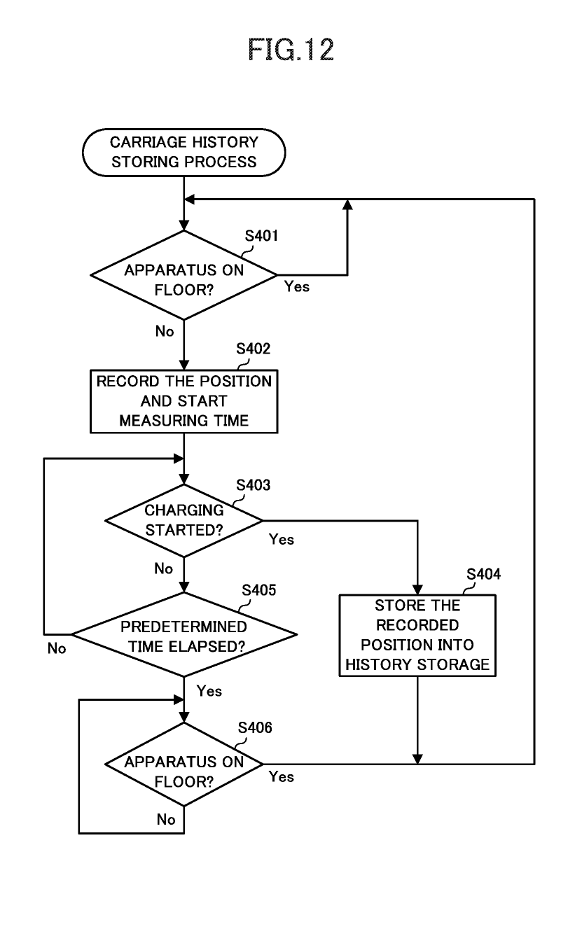

The whole flowchart for the autonomous moving process executed by the autonomous mobile apparatus 101 according to Embodiment 2 is identical to that for the autonomous moving process according to Embodiment 1, as illustrated in FIG. 7. The action planning process executed in step S102 in FIG. 7 is the same as the action planning process according to Embodiment 1 as illustrated in FIG. 8, with the exception that information in the history storage 23 is additionally used in step S202. The normal operation process executed in step S214 in FIG. 8 is the same as the normal operation process according to Embodiment 1, as illustrated in FIG. 9. The threshold correcting process executed by the autonomous mobile apparatus 101 is also the same as the threshold correcting process according to Embodiment 1, as illustrated in FIG. 10, with the exception that, when the autonomous mobile apparatus 101 is powered on, the carriage history storing process is started in another thread concurrently with the other processes described above. The carriage history storing process will now be described with reference to FIG. 12.

First, the controller 10 in the autonomous mobile apparatus 101 determines whether the floor surface sensor 33 has detected that the apparatus 101 is on the floor (step S401). If the apparatus 101 is on the floor (Yes in step S401), the processing returns to step S401 to proceed to determine whether the apparatus 101 is on the floor.

If the apparatus 101 is not on the floor (No in step S401), the controller 10 temporarily stores the current position of the apparatus 101 measured by the position measurer 11 and starts measuring the elapsed time using a timer (step S402).

Next, the controller 10 determines whether the autonomous mobile apparatus 101 is connected to the charger 200 and charging has started (step S403). Whether charging has started can be detected by a charging integrated circuit (IC) included in the autonomous mobile apparatus. If charging has started (Yes in step S403), the controller 10 stores the position of the apparatus 101 that was temporarily stored in step S402 into the history storage 23 (step S404). The presumption can now be made that the apparatus 101 has been carried from the position at that time to the charger 200 manually by a person and then charging has started. Then, the processing returns to step S401.

If charging has not started (No in step S403), the controller 10 determines whether a predetermined time (one minute, for example) has elapsed as measured by the timer (step S405). If the predetermined time has not elapsed (No in step S405), the processing returns to step S403.

If the predetermined time has elapsed (Yes in step S405), the controller 10 determines whether the floor surface sensor 33 has detected that the apparatus 101 is on the floor (step S406). If the apparatus 101 is off the floor (No in step S406), the processing returns to step S406 to proceed to determine whether the apparatus 101 is on the floor. If the apparatus 101 is on the floor (Yes in step S406), the processing returns to step S401.

By executing the carriage history storing process described above, positions at which a person picks up the autonomous mobile apparatus 101 to carry it to the charger 200 are stored into the history storage 23 sequentially. In step S202 in the action planning process (FIG. 8), when the action planner 14 fails to detect a human voice with the microphone 32 or the like or fails to detect a person with the imaging device, the action planner 14 refers to the history storage 23 to specify a location where a person can easily pick up and carry the apparatus to the charger 200 as the destination. If the history storage 23 has not stored any such location yet, the action planner 14 uses the map stored in the map storage 21 to specify a large space having few obstacles 301 nearby as the destination. This is because a large space having few obstacles 301 nearby can be regarded as a location where a person has difficulty in hiding behind an obstacle 301, which in turn can be regarded as a location where a person can easily find the autonomous mobile apparatus 100, as described above.

By executing the process described above, when no person can be detected, the autonomous mobile apparatus 101 according to Embodiment 2 gives a higher priority to, and specifies as the destination, a location where a person picked up the apparatus 101 to carry it to the charger 200 in the past. As a result, the apparatus 101 is more likely to be found by a person.

In the embodiments described above, the action planner 14 sets the position of the charger 200 as the destination when the remaining battery level falls below the threshold TH2, as long as a route to the charger 200 can be created on the basis of the map stored in the map storage 21. However, an area other than the charger 200 may be predetermined, and the action planner 14 may specify the predetermined area as the destination when the remaining battery level falls below the threshold TH2, as long as a route to the predetermined area can be created. For example, a location where the autonomous mobile apparatus 100, 101 is stored or displayed, or any other appropriate location may be specified as the predetermined area. In this case, when the autonomous mobile apparatus 100, 101 runs out of battery in the predetermined area, the user can carry the autonomous mobile apparatus 100, 101 to the charger 200 for charging.

The action planner 14 might possibly determine that the autonomous mobile apparatus 100, 101 is prevented from returning to the charger 200 by an obstacle or the like that has been newly found while the apparatus 100, 101 is moving in an area covering a route to the charger 200. In this case, the action planner 14 may specify the foregoing predetermined area as the destination, triggered by this determination.

The individual functions of the autonomous mobile apparatus 100, 101 can also be implemented by a computer such as a general personal computer (PC). Specifically, the above embodiments have been described with the assumption that programs for the autonomous movement control processing to be executed by the autonomous mobile apparatus 100, 101 are stored in ROM in the storage 20 in advance. Instead, a computer may be configured so that the above-described individual functions can be implemented by distributing the programs stored in a non-transitory computer-readable recording medium, such as a flexible disk, a Compact Disc Read-Only Memory (CD-ROM), a digital versatile disc (DVD), or a magneto-optical disc (MO), and reading and installing the programs onto the computer.

The foregoing describes some example embodiments for explanatory purposes. Although the foregoing discussion has presented specific embodiments, persons skilled in the art will recognize that changes may be made in form and detail without departing from the broader spirit and scope of the invention. Accordingly, the specification and drawings are to be regarded in an illustrative rather than a restrictive sense. This detailed description, therefore, is not to be taken in a limiting sense, and the scope of the invention is defined only by the included claims, along with the full range of equivalents to which such claims are entitled.

What is claimed is:

1. An autonomous mobile apparatus that returns to a charger to be charged, the apparatus comprising:
a determiner that determines whether the apparatus is able to return to the charger;
a location obtainer that obtains a predetermined location;
an action planner that sets a destination, and sets a route to the destination; and
a movement controller that controls a drive so that the apparatus is moved along the route that is set by the action planner,
wherein, when the determiner determines that the apparatus is not able to return to the charger, the action planner sets the predetermined location obtained by the location obtainer as the destination.

2. The autonomous mobile apparatus according to claim 1,
wherein the predetermined location is a location easily found by a person, and the location obtainer includes a person-found location obtainer that obtains a location easily found by a person.

3. The autonomous mobile apparatus according to claim 2,
wherein, when a remaining battery level is lower than a first threshold, the action planner sets a location obtained by the person-found location obtainer as a destination.

4. The autonomous mobile apparatus according to claim 3, further comprising:
a map creator that creates a map in which positions of a charger and an obstacle are recorded; and
a threshold storage that stores a plurality of thresholds for changing operating states depending on a remaining battery level,
wherein the action planner classifies operating states of the apparatus into a plurality of different stages on the basis of relationship of levels between a remaining battery level and each of the thresholds stored in the threshold storage.

5. The autonomous mobile apparatus according to claim 4,
wherein a second threshold stored in the threshold storage is a value greater than the first threshold, and
wherein, when a remaining battery level is lower than the second threshold, the action planner sets a predetermined area as a destination on the basis of a map created by the map creator.

6. The autonomous mobile apparatus according to claim 5,
wherein the predetermined area is a position of a charger.

7. The autonomous mobile apparatus according to claim 6,
wherein, when a remaining battery level is at least equal to the first threshold and lower than the second threshold, and the action planner is unable to set a route to the charger using a map created by the map creator, the action planner randomly sets a destination.

8. The autonomous mobile apparatus according to claim 7, comprising:
a return signal receiver that receives a return signal transmitted by the charger,
wherein a third threshold stored in the threshold storage is a value greater than the second threshold, and
wherein, when a remaining battery level is at least equal to the first threshold and lower than the third threshold, and when the return signal receiver receives a return signal transmitted by the charger, the movement controller controls the drive so that the apparatus is moved to the charger in accordance with the return signal.

9. The autonomous mobile apparatus according to claim 8, having a plurality of operation modes including a map creation mode in which a coverage of the map being created is gradually extended,
wherein, when the operation mode is the map creation mode and a remaining battery level is higher than the third threshold, the action planner sets, as a destination, a point on a boundary between a spot whose map is already created and a spot whose map is not created.

10. The autonomous mobile apparatus according to claim 9,
wherein, when the operation mode is the map creation mode, and a remaining battery level is at least equal to the second threshold and lower than the third threshold, and the return signal receiver has not received the return signal, the action planner sets, as a destination, a point on a boundary between a spot whose map is already created and a spot whose map is not created.

11. The autonomous mobile apparatus according to claim 8, having a plurality of operation modes including a free traveling mode in which the apparatus freely moves,
wherein, when the operation mode is the free traveling mode and a remaining battery level is higher than the third threshold, the action planner randomly sets a destination.

12. The autonomous mobile apparatus according to claim 11,
wherein, when the operation mode is the free traveling mode, and a remaining battery level is at least equal to the second threshold and lower than the third threshold, and the return signal receiver has not received the return signal, the action planner randomly sets a destination.

13. The autonomous mobile apparatus according to claim 4, comprising:
a threshold corrector that periodically corrects a threshold stored in the threshold storage.

14. The autonomous mobile apparatus according to claim 2, comprising:
a history storage that stores a location at which the apparatus is picked up and carried to a charger by a person,
wherein the person-found location obtainer obtains a location stored in the history storage.

15. An autonomous mobile apparatus that comprises a drive and a controller, that autonomously moves owing to the controller that controls driving of the drive in accordance with an environmental map, and that is connected to a separate charger to be charged,
wherein the controller sets switching among a plurality of operating states depending on a remaining battery level, and a threshold at which switching takes place among the plurality of operating states is dynamically corrected in accordance with a predetermined condition.

16. The autonomous mobile apparatus according to claim 15,
wherein the predetermined condition includes at least one of: a rate of failure to return to the charger, a size of the environmental map, sparseness of obstacles, frequency of updating the environmental map, and presence or absence of a person near the apparatus.

17. An autonomous moving method for an apparatus, the method comprising:
a location obtaining step of obtaining a predetermined location;
a determining step of determining whether the apparatus is able to return to a charger;
an action planning step of setting the location obtained in the location obtaining step as a destination, and setting a route to the destination; and
a movement controlling step of controlling a drive so that the apparatus is moved along the route that is set in the action planning step,
wherein, when a determination is made that the apparatus is not able to return to a charger in the determining step, the location obtained in the location obtaining step is set as the destination in the action planning step.

18. A non-transitory computer-readable storage medium storing a program that causes a computer for an autonomous mobile apparatus that returns to a charger to be charged to execute:
a determining step of determining whether the apparatus is able to return to a charger;
a location obtaining step of obtaining a predetermined location;
an action planning step of setting the location obtained in the location obtaining step as a destination, and setting a route to the destination; and
a movement controlling step of controlling a drive so that the apparatus is moved along the route that is set in the action planning step,
wherein, when a determination is made that the apparatus is not able to return to a charger in the determining step, the location obtained in the location obtaining step is set as the destination in the action planning step.
